(19) United States
(12) Patent Application Publication
(10) Pub. No.: US 2022/0140590 A1
(43) Pub. Date: May 5, 2022

(54) END FASTENING PART OF AN ENERGY CHAIN

(71) Applicant: IGUS GMBH, Koeln (DE)

(72) Inventor: Joerg DOMMNIK, Neunkirchen-Seelscheid (DE)

(21) Appl. No.: 17/310,647

(22) PCT Filed: Feb. 17, 2020
(86) PCT No.: PCT/EP2020/054106

§ 371 Date: Aug. 16, 2021

(30) Foreign Application Priority Data
Feb. 15, 2019 (DE) 20 2019 100 877.6

(51) Int. Cl. H02G 11/00; F16G 13/16

(52) U.S. Cl. CPC H02G 11/006; F16G 13/16

(57) ABSTRACT

An end fastening part for an energy chain, for connecting to a link plate of a terminal chain link at one end and to a connection point on a system part at the other end. The single-piece end fastening part has a main plane and comprises: an overlapping region having a side wall for connecting to a link plate; a frame-type fastening region having a frame, in which a plurality of fastening holes is provided, for fastening to a connection point; and, therebetween, a transition region, in which a concave end face is provided. According to the invention, the end face has at least two retaining protrusions, which protrude parallel to the main plane and behind which a link plate can engage such that the link plate is retained transversely to the main plane. Furthermore, the overlapping region has at least one, preferably two fixing protrusions, which protrude from the side wall perpendicularly to the main plane, for fixing a connected link plate in position in the longitudinal direction.

### FIELD

The invention relates to an end fastening part for a cable guide, in particular for an energy chain, for guiding cables, hoses or suchlike between two connection points.

### BACKGROUND

Such end fastening parts are used for connection at one end to link plates of terminal chain links of an energy chain and at the other end to connection points on a fixed or mobile system part or machine part.

A generic end fastening part comprises a main plane with an extension in a longitudinal direction and in a vertical direction perpendicular to the longitudinal direction. In the case of an end fastening part connected to a cable guide, the longitudinal direction corresponds to the longitudinal direction of the fixed end region of the cable guide. A generic end fastening part has at least three sections, in functional terms, related to the longitudinal direction. First, an overlapping region is provided with a side wall for overlapping and connecting to a link plate of a terminal chain link of the energy chain. Secondly, a frame-shaped fastening region is provided with a frame, in particular a surrounding frame in which a plurality of fastening holes are provided parallel to the main plane, by means of which the end fastening part can be fastened to a connection point, in particular by means of a screw connection. Thirdly, a transition region is provided between the overlapping region and the fastening region. In this transition region, a concave, in particular essentially arc-shaped end face is usually provided which matches the end face of the link plate. The shape of the end face can in particular correspond or be complementary to the shape of the end face of the link plate.

Such end fastening parts are known for example from DE4313082C2 or DE9412252U1. They comprise a joint area inside the overlapping region for the articulated connection to the link plate of the terminal chain link. For this purpose, the side wall of the overlapping region comprises a joint bolt and a joint mount in order to be connected to the corresponding bolt or the mount of the link plate via a pinhole connection. Accordingly, separate, different end fastening parts, each with a joint bolt or with a joint mount, must be provided for both ends of the energy chain.

### SUMMARY

The problem of the present invention is to propose an end fastening part which is suitable for connecting to both one and the other end of an energy chain, and particularly preferably for connecting to each of the four terminal link plates of an energy chain, and can be produced in a simple and cost-effective manner.

This problem is solved according to the invention with an end fastening part, wherein the end face in the transition region of the end fastening part comprises at least two retaining protrusions which extend parallel to the main plane from the end face and project over the overlapping region, behind which a connected or to be connected link plate can engage. The retaining protrusions hold the connected link plate transversely to the main plane or against pivoting out of this plane. A longitudinal end of the link plate can thus be received, relative to the direction perpendicular to the main plane, between the retaining protrusions or between a retaining protrusion and the side wall of the overlapping region and can be held in the direction perpendicular to the main plane of the end fastening part by the retaining protrusion or retaining protrusions.

According to the invention, the overlapping region can also comprise at least one, preferably two, fixing protrusions, which project from the side wall in the direction perpendicular to the main plane and to which a connected link plate can be connected for fixing the position in the longitudinal direction.

The at least one fixing protrusion can cooperate with a special connecting device on the link plate to be connected, in order to fix the position of the link plate connected to the end fastening part in the longitudinal direction. Longitudinal securing of conventional components of link plates already present also lies within the scope of the invention, e.g. by engaging over the narrow side and holding on both sides a crossbar, a fastening projection or a fastening recess for a crossbar.

In contrast with known end fastening parts, the end fastening part according to the invention does not require any lug-specific means for connecting to the articulated region of the link plate. Amongst other things, this allows greater manufacturing tolerance in the production of the end fastening part and compatibility with link plates of different sizes and plate series.

The at least one fixing protrusion is spaced apart from the end face and the retaining protrusions in the longitudinal direction. The greatest distance measured along the longitudinal direction can correspond to approximately half a chain pitch of a chain link to be fastened or half the longitudinal extension of a connected link plate. In the connected state, the at least one fixing protrusion can thus lie in the middle of the link plate with respect to the longitudinal direction, i.e. can be connected to a central link region or lie centrally between the longitudinal ends of the link plate.

The part overlapping with the end fastening part or the longitudinal end of the link plate can be received at least in sections between a retaining protrusion and the side wall or between two retaining protrusions and can be fixed transversely to the longitudinal direction and optionally also transversely to the height direction. By a suitable form-fit and/or force-fit connection with the at least one fixing protrusion, the link plate can in turn be fixed in the longitudinal direction against high tensile forces and held firmly in position.

The end fastening part according to the invention has the advantage that it can be connected both to link plates which have a joint bolt and also to link plates that have a joint mount. Thus, an end fastening part of the same type can be used to fasten both ends of an energy chain at correspondingly provided connection points. The end fastening part according to the invention can, if appropriate, also be connected to a side part of a cable guide corresponding to a link plate, which is not an actual link chain, since it has neither a joint bolt nor a joint mount. The end fastening part can thus be used for the end fastening of different types of cable guides. This reduces the number of components.

The end face in the transition region of the end fastening part can comprise two first retaining protrusions projecting towards the main plane and at least one second retaining protrusion protruding towards the main plane, wherein the first retaining protrusions can be arranged in the direction transverse to the main plane offset with respect to the at least one second retaining protrusion. Particularly preferably, all the retaining protrusions run parallel to the main plane of the end fastening part.

The first retaining protrusions offset from one another in the direction perpendicular to the main plane and the at least one second retaining protrusion allow, in particular in the case of bent link plates, the outwardly or inwardly bent region of a link plate to be received optionally between the first and the at least one second retaining protrusion or between the side wall and the at least one second retaining protrusion and it to be held parallel to the main plane.

The retaining protrusions can be constituted tongue-like. In particular, they can extend over a small part of the radian dimension in the of the preferably arc-shaped end face, in particular by less than a third of the radian dimension. The shape facilitates the manufacture of the end fastening part, in particular in the injection moulding process, and enables the use of less complicated and more favourable injection moulds.

The end face with the retaining protrusions is arranged transversely, preferably perpendicular to the main plane of the end fastening part. In the case of a flat overlap of the overlapping region with the link plate, the end surface of the end face is facing the link plate. The end face does not necessarily have to have the shape of a segment of a circle, it can also have a shape of a multi-cornered polygon or suchlike.

A plurality, in particular at least one pair of fixing protrusions are preferably provided on the end fastening part. The fixing protrusions are preferably arranged at a distance from one another in the height direction of the side wall or in the height direction of the end fastening part. The fixing protrusions of a pair preferably have the same position with respect to the longitudinal direction or are arranged on one and the same line, which runs parallel to the height direction and perpendicular to the longitudinal direction.

The fixing protrusions can be designed in particular for form-fit and/or force-fit connection to a link plate to be connected.

The fixing protrusions are preferably formed in one piece with the side wall of the overlapping region. This simplifies production, facilitates assembly and increases the stability of the fastening.

Each fixing protrusion is preferably designed for snap connection with a link plate to be connected, in particular in the manner of a clip for the snap connection, in each case with a complementary recess in the link plate. Alternatively or in addition, the fixing protrusions can be designed as a pair of opposing claws or double snap hooks on the upper and lower narrow side of the side wall of the overlapping region for engaging around conventional crossbars or a peg or horn for a crossbar.

In one embodiment, the fixing protrusions project in the direction perpendicular to the main plane from the side wall of the end fastening part, in particular up to a plane which extends parallel to the main plane between the first and second retaining protrusions, so to speak with a transverse length which in front view ends between the first and second retaining protrusions. In other words, the extension of the fixing protrusions in the direction perpendicular to the main plane can be greater than the distance of the first retaining protrusion from the side wall and smaller than the corresponding distance of the second retaining protrusions. This allows the link plate to be inserted easily at an angle to the main plane of the end fastening part and still provides a stable longitudinal securing means.

In a preferred embodiment, the end fastening part has a longitudinal median plane which extends perpendicular to the main plane of the end fastening part, at least the retaining protrusions and the at least one fixing protrusion being arranged mirror-symmetrical to this longitudinal median plane. The end fastening part can, in particular, be constituted overall mirror-symmetrical with respect to the longitudinal median plane. This offers the advantage that one and the same end fastening part can be connected to each of the total of four ends of the link strands of an energy chain due to the symmetry. Thus, only one embodiment of the end fastening part is necessary at least for a possible plurality of chain types.

The side wall of the overlapping region preferably has a dimension in the longitudinal direction starting from the end face that is larger than half the chain pitch of the chain link to be fastened. Thus, in the connected state of the end fastening part, the side wall can project up to over the central region of the fastened link plate.

The at least one fixing protrusion, in particular the two fixing protrusions, are preferably arranged in a height plane which lies at a distance corresponding to half the chain pitch of a chain link to be fastened from the end face or in a plane which intersects the central region of a connected link plate. The height plane extends perpendicular to the main plane of the end fastening part and perpendicular to the longitudinal median plane or longitudinal direction. The distance of the height plane from the end face is understood here to mean the distance along the line at which the longitudinal median plane crosses the main plane.

Thus, the extension of the overlapping region of the end fastening part in the longitudinal direction is preferably greater than half the longitudinal extension of a link plate to be connected. Accordingly, the at least one fixing protrusion can lie in a region with respect to the longitudinal direction that overlaps with a central region of the connected link plate and can interact with it, e.g. with a complementary device in the central region. If a fixing protrusion is designed, for example, as a clip or latching clip, it can cooperate with a recess or latching recess in the link plate. Alternatively, fixing protrusions can be designed as a pair of snap hooks which engage around a peg for a crossbar or a crosspiece.

The end fastening part can preferably be produced in one piece from plastic, in particular by in the injection moulding process, and can be produced using simple moulding tools. For production in the injection moulding process, it is expedient for each retaining protrusion to be provided with an associated opening in the side wall, which is aligned with the respective retaining protrusion perpendicular to the main plane and the contour whereof, viewed in side view, frames the contour of the assigned retaining protrusion. The area of the opening can be equal to or slightly larger than the area of the associated retaining protrusion. This simplifies the production of the retaining protrusions and the undercut under each retaining protrusion, which enables the use of simple two-part injection moulds, in particular without a slider or suchlike.

In one embodiment, the frame-shaped fastening region on the inner side of the surrounding frame can have an extension for holding a C-rail on both sides of the longitudinal median plane, which in turn serves to fasten strain relief devices. Alternatively or in addition, a fitting for comb-like strain relief can be provided on the inner side of the surrounding frame on both sides of the longitudinal median plane. Thus, the strain relief can be assembled together with two opposite end fastening parts in one step, and the energy chain fitted or preassembled with cables in the factory can be supplied ready for connection. The inner side of the frame, as well as the inner side of the end fastening part as a whole, faces a receiving space of the energy chain or the guided cables in the connected state of the end fastening part.

The side wall of the overlapping region can have a significantly smaller wall thickness than the frame of the fastening region, in particular <50% of the wall thickness of the frame, amongst other things for the purpose of saving material. If the overlapping region is connected to a link plate, the joint wall thickness of the overlapping region with the link plate can thus remain smaller than the wall thickness of the frame.

### BRIEF DESCRIPTION OF THE DRAWINGS

Further details, features and advantages of the invention will emerge from the following detailed description of preferred examples of embodiment by reference to the appended drawings. In the latter:

FIG. 1a: shows a cross-sectional view of the end regions of an energy chain with connected end fastening parts according to a first example of embodiment;

FIG. 1b: shows an enlarged detail view according B according to FIG. 1a;

FIG. 1c: shows an enlarged detail view according C according to FIG. 1a;

FIG. 2a: shows a side view of the end fastening part according to the first example of embodiment;

FIG. 2b: shows a longitudinal section A-A corresponding to FIG. 2a;

FIG. 2c: shows a perspective view of the end fastening part according to FIG. 2a; and

FIG. 3: a side view of an end fastening part according to a second example of embodiment.

### DETAILED DESCRIPTION

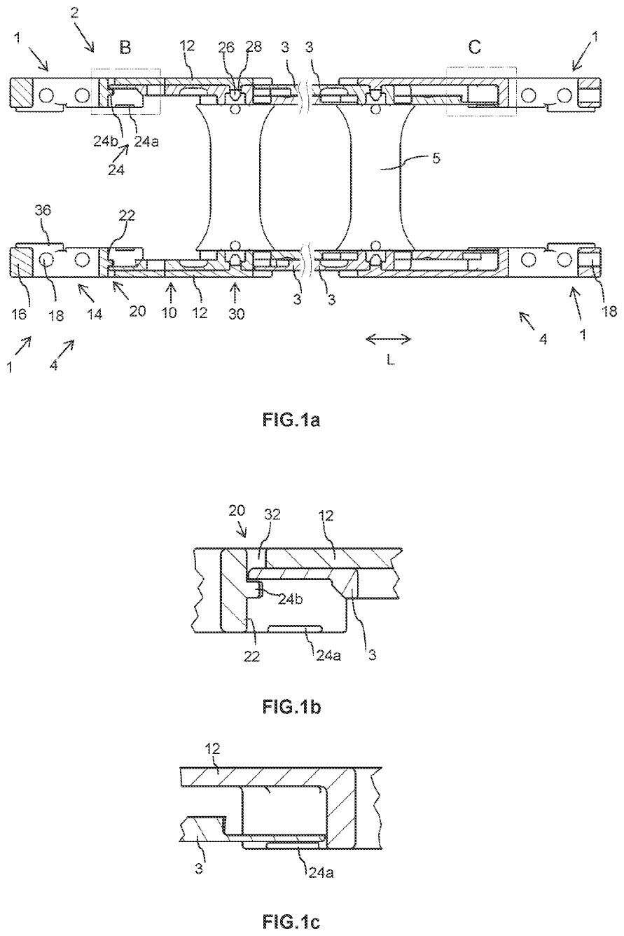

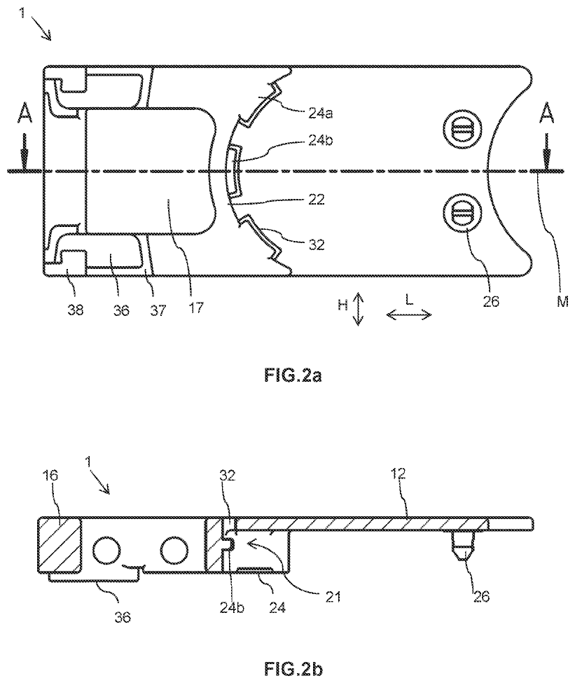

FIG. 1a shows two terminal regions of an energy chain 2 with four identical end fastening parts 1, which are connected to the four link plates 3 of the two terminal chain links 4, in order to fastening the latter to a connection point. FIG. 2b shows a longitudinal cross-section of a non-connected end fastening part 1.

Each end fastening part 1 is designed flat with a main plane perpendicular to the plane of FIG. 1a. The longitudinal direction L lies in the main plane, which in the illustrated connected state corresponds to the longitudinal direction of the terminal chain link of energy chain 2 or the cables routed-through there, and height direction H, which runs in the main plane perpendicular to longitudinal direction L.

End fastening part 1 has in relation to longitudinal direction L three functional regions—and overlapping region 10, a fastening region 14, and a transition region 20 between overlapping region 10 and fastening region 14. Overlapping region 10 overlaps, in the connected state of end fastening part 1, with a terminal link plate 3 up to over a central region 30 of link plate 3. Fastening region 14 is used for fastening to one of the connection points of energy chain 2, for example to a stationary or mobile machine part.

Overlapping region 10 has a side wall 12, which extends parallel to the main plane and end fastening part 1 and borders end fastening part 1 in the transverse direction perpendicular to the main plane. Fastening region 14 is essentially formed by a frame 16. Frame 16 surrounds in the present example a window 17 which is designed as a continuous opening in the transverse direction. Window 17 can be closed with a side wall similar to side wall 12. Side wall 12 of overlapping region 10 has a much smaller wall thickness than frame 16 of fastening region 14, in the present example approximately ⅙ of the wall thickness of frame 16.

Due to the difference in the wall thickness between fastening region 14 and overlapping region 10, end attachment part 1 comprises in its transition region 20 an offset 21 or a bent portion, and forms an end face 22, which runs essentially perpendicular to the main plane of end fastening part 1. End face 22 is facing an end face of link plate 3 in the connected state.

As can best be seen in FIG. 1b and FIG. 1c, individual protruding retaining protrusions 24 are provided at end face 22. Retaining projections 24 are designed as tongues, which run here parallel to the main plane of end fastening part 1 and lie at a distance from side wall 12 in the direction perpendicular to the main plane. An end region of link plate 3 can accordingly be introduced and accommodated between retaining protrusions 24 and side wall 12 or engage behind the latter.

In FIG. 1-3, three retaining protrusions 24 are formed at end face 22—two first retaining protrusions 24a and a second retaining protrusion 24b. Second retaining protrusion 24b lies closer to side wall 12 than first retaining protrusions 24a. Here, first retaining protrusions 24a lie in the direction perpendicular to the main plane, flush with frame 16. The outwardly or inwardly bent end region of link plate 3 can thus be accommodated optionally between first and second retaining protrusion 24a, 24b, as in FIG. 1c, or between side wall 12 and second retaining protrusion 24b, as in FIG. 1b. Each of retaining protrusions 24a, 24b extend in the present example over approximately a fifth of the radian dimension of end face 22.

FIG. 2a shows, in respect of the first example of embodiment of end fastening part 1, two fixing protrusions 26, which are arranged mirror-symmetrical with respect to longitudinal median plane M. Longitudinal median plane M runs perpendicular to the main plane of end fastening part 1 (and perpendicular to the plane of FIG. 2a). Retaining protrusions 24 are also constituted and arranged mirror-symmetrical with respect to longitudinal median plane M. This symmetry allows a rotation of end fastening part 1 in the plane parallel to the main plane, so that it can optionally fasten the one or the other link strand of energy chain 2 at the end.

As can be seen in FIGS. 2b and 2c, fixing protrusions 26 are designed as clip connectors for the snap connection or latching, in each case with a complementary recess 28 in link plate 3. Each fixing protrusion 28 comprises a longitudinally slotted head at the end with resilient latching hooks. Once accommodated in recess 28, fixing protrusions 26 can prevent both a displacement of end fastening part 1 in longitudinal direction L and also in height direction H. Recesses 28 can be provided in central region 30 of link plate 3 or exactly in the middle with respect to the longitudinal direction.

End fastening part 1 is produced in one piece from plastic in the injection moulding process. Openings 32 behind each retaining protrusion 24 can be seen in FIG. 2a, the respective areas of which are somewhat larger than the areas of associated retaining protrusions 24, so that the contour of openings 32 behind retaining protrusions 24 can be seen in side view in FIG. 2a, in order to be able to use simple, two-part injection moulds for forming retaining protrusions 24a, 24b.

Frame 16 of fastening region 14 is provided with fastening holes 18. Two fastening holes in each case emerge at each of three narrow sides of frame 16. Fastening holes 18 emerge at the other side into window 17. Fastening holes 18 are used for fastening by means of screw connection, optionally with metal bushings (not shown) in fastening holes 18, at a connection point.

As represented in FIG. 2a, 2c, frame 16 comprises at its inner side 34, in each case on both sides of longitudinal median plane M, an extension 36 and in each case a fitting. A metal profile, e.g. a C-rail (not shown), can be attached to extension 36, so that the end faces of a C-rail engage around extension 36 in a form-fit manner. Inner side 34 of frame 16 also comprises a pocket 37 matching the end face of the C-rail, which flanks or surrounds extension 36. Such metal profiles or C-rails are used for fastening to strap clips known per se for strain relief of cables. Thus, the one or other type of strain relief can optionally be used on end fastening part 1.

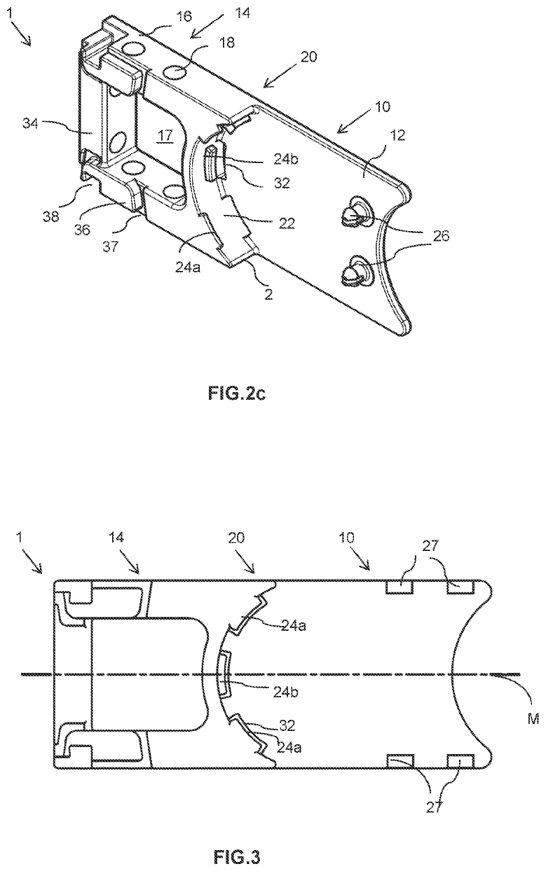

FIG. 3 shows an end fastening part 1 according to a modified second example of embodiment, which differs from the first example of embodiment only by the type of fixing protrusions 27. Here, fixing protrusions 27 are designed as a pair of double snap hooks 27. Each of double snap hooks 27 can engage around the fastening peg for a crossbar 5, which is present at link plate 3 to be connected, and at both sides with respect to the longitudinal direction and abut against an inner side of link plate 3. Two snap hooks 27 provided in pairs on both sides of longitudinal median plane M can thus hold link plate 3 both in the longitudinal direction and also perpendicular thereto.

### LIST OF REFERENCE NUMBERS

1 End fastening part
2 Energy chain
3 Link plate
4 Terminal chain link
5 Crossbar
10 Overlapping region
12 Side wall of overlapping region
14 Fastening region
16 Frame
17 Window
18 Fastening holes
20 Transition region
21 Offset
22 End face
24 Retaining protrusions
24a First retaining protrusions
24b Second retaining protrusions
26, 27 Fixing protrusions
28 Recess
30 Central region of the link plate
32 Opening
34 Inner side of the frame
36 Extension
37 Pocket
38 Fitting
L Longitudinal direction
H Height direction
M Longitudinal median plane

What is claimed is:

1-10. (canceled)

11. An end fastening part for an energy chain for guiding cables, hoses or suchlike between two connection points, wherein the end fastening part comprises a main plane and is constituted in one piece, comprising:
an overlapping region with a side wall for connecting to a link plate of a terminal chain link of the energy chain; and
a frame-shaped fastening region with a frame, in which a plurality of fastening holes are provided, by means of which the end fastening part can be fastened to a connection point, by means of a screw connection, wherein in a transition region between the overlapping region and the fastening region, a concave end face is provided, wherein the end face comprises at least two retaining protrusions which project parallel to the main plane, behind which a link plate can engage in order to hold the latter transversely to the main plane, and that the overlapping region comprises at least one fixing protrusions, which project perpendicular to the main plane from the side wall, to which a connected link plate can be connected for fixing the position in the longitudinal direction.

12. The end fastening part according to claim 11, wherein the end face comprises two first retaining protrusions projecting offset relative to the main plane and at least one second retaining protrusion protruding offset relative to the main plane, wherein the first retaining protrusions are arranged in the direction transverse to the main plane offset with respect to the at least one second retaining protrusion.

13. The end fastening part according to claim 11, wherein two fixing protrusions are provided at a distance from one another in the height direction of the side wall and are designed for form-fit and/or force-fit connection to a connected link plate.

14. The end fastening part according claim 11, wherein each fixing protrusion is designed for snap connection with a connected link plate, in the manner of a clip for the snap connection, in each case with a complementary recess in the link plate.

15. The end fastening part according to claim 11, wherein each fixing protrusion projects in the direction perpendicular to the main plane from the side wall up to a spacing between the first and second retaining protrusions.

16. The end fastening part according to claim 11, wherein the end fastening part has a longitudinal median plane and at least the retaining protrusions and the at least one fixing protrusion are arranged symmetrically with respect to the latter.

17. The end fastening part according to claim 11, wherein the side wall has a dimension in the longitudinal direction starting from the end face that is larger than half the chain pitch of a chain link to be fastened or projects up to over the central region of a connected link plate, and that the fixing protrusions are arranged in a height plane, which lies at a distance from the end face corresponding to half the chain pitch of a chain link to be fastened or intersects the central region of a connected link plate.

18. The end fastening part according to claim 11, wherein the end fastening part is produced in one piece from plastic, and an associated opening in the side wall is provided, in each case, in respect of each retaining protrusion, which is aligned with the respective retaining protrusion perpendicular to the main plane and the contour whereof frames the contour of the assigned retaining protrusion.

19. The end fastening part according to claim 11, wherein two extensions are provided at inner side of the frame on both sides for holding a C-rail for strain relief and/or two fittings are provided for comb-like strain relief.

20. The end fastening part according to claim 11, wherein the side wall has a significantly smaller wall thickness than the frame, in particular <50% of the wall thickness of the frame.
